(19) United States
(12) Patent Application Publication
(10) Pub. No.: US 2011/0193709 A1
(43) Pub. Date: Aug. 11, 2011

(54) MOBILE DEVICE AND METHOD OF DETECTING TEMPERATURE

(75) Inventor: ZHI-PENG MA, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/764,070

(22) Filed: Apr. 20, 2010

(30) Foreign Application Priority Data
Feb. 8, 2010 (CN) 201010301347.1

(51) Int. Cl. G08B 17/00

(52) U.S. Cl. 340/584

(57) ABSTRACT

A mobile device includes a temperature sensing module, a determination module, and a warning module. The temperature sensing module detects a body temperature. The determination module determines whether the body temperature is beyond a predetermined temperature. The warning module sends a warning when the body temperature is beyond a predetermined temperature.

### BACKGROUND

1. Technical Field

The present disclosure relates to a mobile device and a method of detecting temperature using the mobile device.

2. Description of Related Art

A mobile phone or cell phone is an electronic device used for mobile telecommunications (telephone, text messaging or data transmission) over a cellular network of specialized base stations known as cell sites. In addition to the standard voice function, current mobile phones may support many additional services. Mobile phones are expected to have more functions. One such function that is needed is the function of temperature checking, most public service area now include infrared thermometers checking people coming and going, having a warning for a personal high body temperature would add convenience and save time and sometimes embarrassment.

### BRIEF DESCRIPTION OF THE DRAWINGS

FIG. 1 is a block diagram of a mobile device in accordance with an exemplary embodiment.

FIG. 2 shows a flowchart of a method of detecting temperature in a mobile device in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

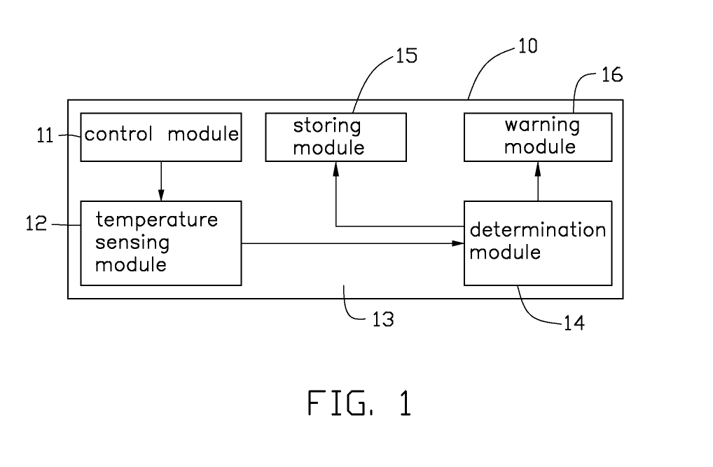

Referring to FIG. 1, a mobile device 10 includes a control module 11, a temperature sensing module 12 connecting to the control module 11, a determination module 14, a storing module 15 and a warning module 16. In one embodiment, the mobile device 10 is a mobile phone for measuring body temperature. The temperature sensing module 12 is an infrared thermometer.

The mobile device 10 has a switch button to start up the control module 11. The control module 11 starts the temperature sensing module 12. The temperature sensing module 12 detects the body temperature sends the body temperature to the determination module 14.

The determination module 14 sets a predetermined temperature. The determination module 14 determines whether the body temperature is beyond the predetermined temperature. If the body temperature is not beyond the predetermined temperature, the determination module 14 sends the body temperature to the storing module 15. If the body temperature is beyond the predetermined temperature, the warning module 16 is started. The warning module 16 warns a user that their body temperature is abnormal. When the warning module 16 is started, the warning module 16 sends a warning. The warning can be given in many ways, such as ringing, vibration, or video output. The storing module 16 records the time and the body temperature in the mobile device 10.

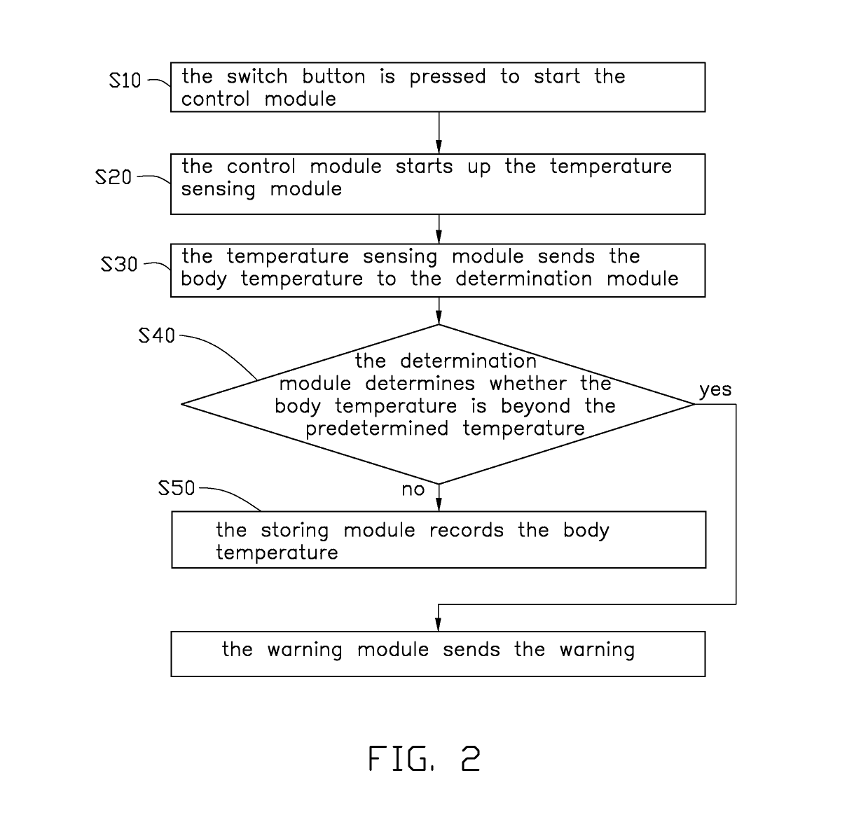

Referring to FIG. 2, one embodiment of a method of detecting temperature in a mobile device includes the following blocks.

In block S10, the switch button is pressed to start the control module 11.

In block S20, the control module 11 starts up the temperature sensing module 12. The temperature sensing module 12 detects the body temperature.

In block S30, the temperature sensing module 12 sends the body temperature to the determination module 14.

In block S40, the determination module 14 determines whether the body temperature is beyond the predetermined temperature. If yes, the warning module 16 sends the warning. If no, it goes to S50.

In block S50, the storing module 15 records the body temperature.

While the present disclosure has been illustrated by the description of the embodiments thereof, and while the embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A mobile device comprising:
a temperature sensing module detecting a body temperature;
a determination module determining whether the body temperature is beyond a predetermined temperature;
a warning module sending a warning when the body temperature is beyond a predetermined temperature.

2. The mobile device of claim 1, wherein the mobile device is a mobile phone, the warning is one of ringing, vibration and video output.

3. The mobile device of claim 1, wherein the mobile device further comprises a control module starting the temperature sensing module, the mobile device comprises a switch button starting up the control module.

4. The mobile device of claim 1, wherein the temperature sensing module is an infrared temperature sensor collecting the body temperature.

5. The mobile device of claim 4, wherein the mobile device further comprises a storing module recording time and the body temperature.

6. A method of detecting temperature in a mobile device, the method comprising:
detecting and sending a body temperature through a temperature sensing module;
determining whether the body temperature is beyond a predetermined temperature via a determination module; and
sending a warning when the body temperature is beyond a predetermined temperature by a warning module.

7. The method of claim 6, wherein the mobile device is a mobile phone, the warning is one of ringing, vibration and video output.

8. The method of claim 6, wherein the mobile device further comprises a control module starting the temperature sensing module, the mobile device comprises a switch button starting up the control module.

9. The method of claim 6, wherein the temperature sensing module is an infrared temperature sensor collecting the body temperature and sending the body temperature to the determination module.

10. The method of claim 6, wherein the mobile device further comprises a storing module storing time and the body temperature.
